(19) United States
(12) Patent Application Publication
(10) Pub. No.: US 2010/0153501 A1
(43) Pub. Date: Jun. 17, 2010

(54) BUSINESS PROCESS INFORMATION SYSTEM

(76) Inventors: Jan Gabriel, Rauenberg (DE); Tim Kornmann, Wiesloch (DE)

Correspondence Address: MINTZ, LEVIN, COHN, FERRIS, GLOVSKY & POPEO, P.C., ONE FINANCIAL CENTER, BOSTON, MA, 02111, US

(21) Appl. No.: 12/335,407

(22) Filed: Dec. 15, 2008

(51) Int. Cl. G06F 15/16

(52) U.S. Cl. 709/206

(57) ABSTRACT

A data structure, such as a business object, is monitored to detect changes. Upon detection of the changes, a push service is initiated. Thereafter, the push service packages determines if such changes are relevant, and if so, data characterizing the save event in a message in a predetermined format. The message is later transmitted to an output management module so that the output management module initiates delivery of a notification message to at least one predetermined recipient by a predetermined communication channel. Related apparatus, systems, techniques and articles are also described.

### TECHNICAL FIELD

The subject matter described herein relates to selectively delivering information relating to business processes.

### BACKGROUND

In most business systems, people involved in business processes often do not directly receive information about the status of the business processes. People obtain such information mainly in case of exceptions (e.g., alerts, etc.). In order to ensure that a person is fully informed about the status of a business process, he or she needs to have direct access to the underlying system or systems conducting such processes. However, such direct access can be difficult when a person is outside of a work environment (e.g., on travel, etc.) or if such a person is not trained to use the underlying systems. In addition, even if an person is within a work environment, reports, monitors, user interfaces and/or work centers may only be available in different business systems, thereby requiring the person to log in an access applications on each such business system.

### SUMMARY

In one aspect, a data structure is monitored in a save phase to detect data changes. In response to detection of the data structure changes, a push service is initiated. The push service examines the changes and in case they are relevant then packages the data characterizing the changes in a message in a predetermined format. The message is transmitted to an output management module which in turn initiates delivery of a notification message to at least one predetermined recipient by a predetermined communication channel.

The data structure can be, for example, a business object. The framework, for example, can be a service-oriented architecture. A process agent can be what monitors the business object in order to detect data changes on the structure during save phase.

A formula and derivation tool repository can be accessed to determine one or more of the predetermined message format, the at least one predetermine recipient, and the predetermined communication channel. The formula and derivation tool repository can define user-generated information filters. Such information filters are rules which define the relevant data changes and can be defined, for example, via a graphical user-interface.

A business configuration module can define at least a portion of the predetermined message format. The format defined by the business configuration module can be further limited by rules in the formula and derivation tool repository.

The communication channel can be a wireless messaging service, e-mail service, or XML adapter.

A recipient of the notification message can generate a response which initiates further action. The further action can result in delivery of additional information relating to the data changes of the save phase to the at least one predetermined recipient via the predetermined communication channel. The further action can additionally or alternatively result in at least one additional processing step relating to the save event being initiated. The response can invoke an A2X service.

In an interrelated aspect, an asynchronous process agent can initiate a push service when a save event occurs in a business object the asynchronous process agent is registered to. The asynchronous process agent can provide the push service with data characterizing the save event. The push service invokes the formula and derivation tool which runs the user defined information filters and their rules on the data changes to determine a notification event. A business configuration module in the push service subsequently modifies the data changes into a format compatible with the notification event. Thereafter, an information outbound module in the push service transmits the data into a format compatible with the notification event to an outbound management module. Transportation of the data characterizing the save event into a format compatible with the notification event is initiated via a delivery channel specified by the formula and derivation tool to a user. Feedback is then received from the user to enable initiation of a core service of the business object.

An output management module can initiate the transport of the data characterizing the save event. The output management module can receive a user-generated response which can result in calling an information inbound module in the push service with the response, invoking, by the information inbound module, an A2X service defined by the response, and invoking, by the A2X service, the core service associated with the data structure. Such an arrangement is relevant for SMS and e-mail response channels. In other implementations (e.g., web service response channels), the feedback can be directly received via an A2X service invocation.

Articles are also described that comprise a machine-readable medium embodying instructions that when performed by one or more machines result in operations described herein. Similarly, computer systems are also described that may include a processor and a memory coupled to the processor. The memory may encode one or more programs that cause the processor to perform one or more of the operations described herein.

The subject matter described herein provides many advantages. The business process information system closes the information gap between the running business processes being encapsulated in the business system(s) and the various people involved by distributing real-time information about the running business process. By providing mechanisms for distributing (pushing) business process information to multiple users/consumers in time, there is no need for users to have direct access to the underlying systems that affect such business processes.

Use case scenarios that are enabled by the current subject matter include: “a manager in an offsite meeting wanting to be updated about the status of a particular customer, and in particular, whether there are any noteworthy incidents relating to the customer”; “a strategic purchaser wants to be informed by e-mail about every new quote that has been posted by a supplier”; “a material planner wants to receive an SMS when a particular good has been delivered”; “a key account manager wants to be notified via SMS when a particular customer places a purchase order above a predetermined level”; “a project manager wants to be informed via e-mail when a time critical purchase order is rejected”; “a manager wants to receive an XML message on his mobile phone to approve a critical shopping cart”; and “a purchasing unit manager needs to be informed via an XML message when a specific strategic and expensive product is ordered”.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating a technique for selectively delivering alerts relating to business processes;

FIG. 2 is a first diagram illustrating a business process platform;

FIG. 3 is a second diagram illustrating a business process platform; and

FIG. 4 is a diagram illustrating business process registration.

Like reference symbols in the various drawings indicate like elements.

### DETAILED DESCRIPTION

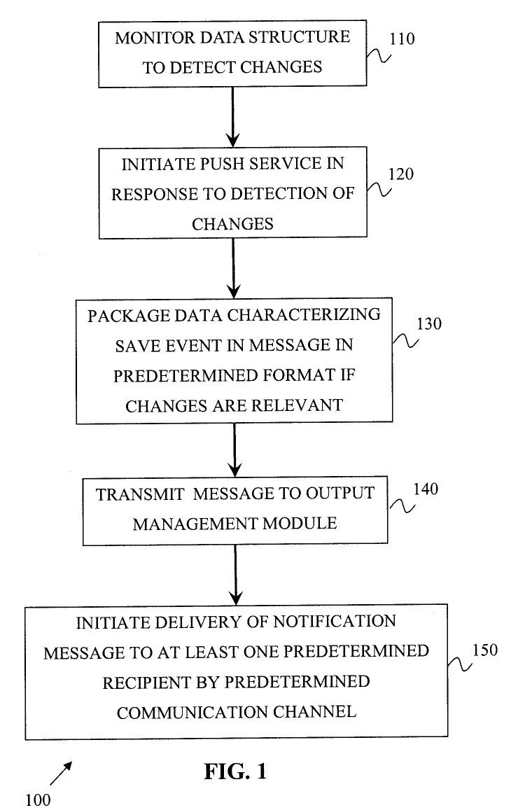

FIG. 1 is a process flow diagram illustrating a method 100, in which at 1110, a data structure is monitored to detect changes in the save phase (save transaction process). Upon detection of changes, at 120, a push service is initiated. Thereafter, at 130, the push service determines the relevant data changes and packages them in a message in a predetermined format. The message is later transmitted, at 140, to an output management module so that the output management module, at 150, initiates delivery of a notification message to at least one predetermined recipient by a predetermined communication channel.

With the current subject matter, consumers can register themselves to information of interest. They can choose a detail level of information for which they want to be informed. They can choose a communication modality to receive such information (e.g., e-mail, XML, SMS, MMS, etc.) such that the relevant information is pushed without the consumer having to log one's self into a particular application. Moreover, such information can be actionable, in that the consumers can take action on the information that is pushed to them.

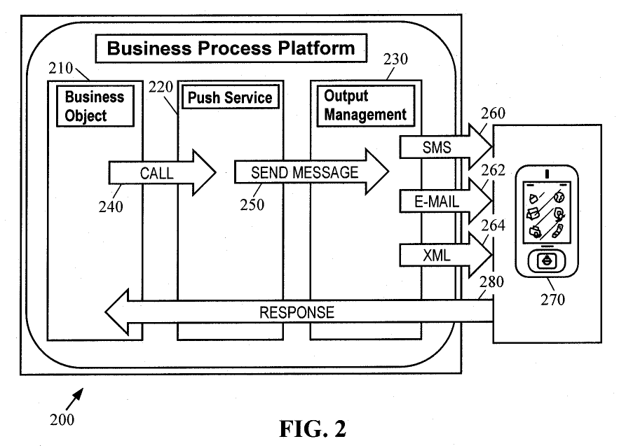

FIG. 2 is a diagram 200 that illustrates a business process platform 200 that includes a business object 210, a push service 220, an output management module 230, and a consumer device 270. A change in the business object 210 (other data structures can be utilized depending on the desired implementation) initiates a call 240 to initiate the push service 220. The push service 220 in turn sends a message to the output management module 230, which based on pre-defined rules, sends a notification message via a desired modality (e.g., SMS 260, e-mail 262, XML 264, etc.) to the desired recipient (in this case the consumer device 270). In some implementations, the notification can be actionable in that the user at the consumer device 264 can send a response 280 to the notification which can result in a subsequent action occurring (e.g., more information about the alert being sent, approval of transaction, etc.).

The call 240 can be initiated, for example, when a save transaction occurs in connection with the business object 210. A process agent can be associated with the business object 210 that is triggered to execute the push service 220. In some implementations, the process agent can be one of a plurality of generic process agents that are registered for each of a plurality of business objects 210. The push service 220 can, for example, read a business configuration, invoke the configured rules in a formula and derivation tool to detect if the changes to the business object data 210 is relevant for a notification event, and if a notification is to be sent, it can call the output management module 230 to send out the notification via one or more of the communication channels 260, 262, 264. In cases of XML output, consumers can, in some variations, invoke A2X services to, for example, read additional data, or take further actions. Alternately, the output management module 230 can be configured to receive the response 280 and initiate further actions depending on the contents of the response 280.

Business objects can be characterized as real world entities modeled as objects in an information system. Business objects encapsulate both data structures and the functions (core services) applied to the data, while hiding their full complexity from other objects. This encapsulation of data and functions makes it easier to modify program components by allowing one to program with the relevant entities without having to know all the implementation details. Business objects also allow for the reuse of existing functions.

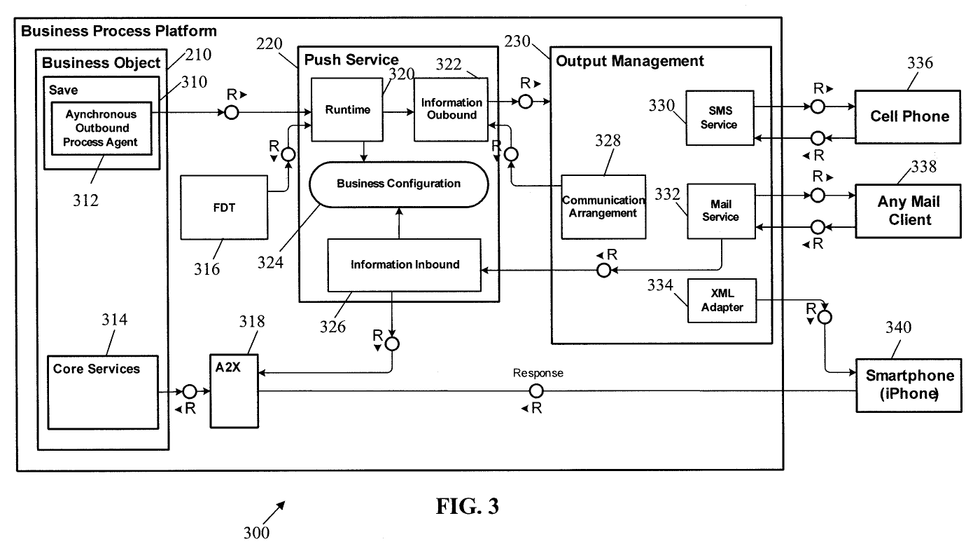

FIG. 3 is a diagram illustrating a business process platform 300 that includes the business object 210, the push service 220, and the output management module 230. The business process platform 300, can, for example, be implemented as part of a service-oriented architecture. The business object 210 can include an asynchronous outbound process agent 312 that is triggered when a save transaction process 310 occurs (either with any entity of the business object 210 or one of a subset of entities of the business object 210). The asynchronous outbound process agent 312 executes a foundation runtime 320 which is part of the push service 220 and which assembles a notification message and initiates the transmission of the message to registered users via predefined communication channels. The foundation runtime 320 can access a business configuration module 324 to what information characterizing the save transaction process 310 should be presented to a user (if at all) (i.e., which business object 210 information is to be included in an alert).

The foundation runtime 320 can also call a FDT repository 316 which includes information filters relating to the save transaction process (rules defined by a user about which business object 210 data changes are relevant for a notification event—e.g. a change to Purchase Order business object status or item amount). The foundation runtime 320 can invoke an information outbound module 322 (once relevant information on how a notification should be constructed and any filters that should be applied to the save transaction process 310 data in the call) which calls the output management module 320. If the call to the output management module 320 does not specify a communication channel, a communication arrangement module 328 within the output management module 320 can call the information outbound module 322 to obtain such information. The output management module 230 can then initiate delivery of an alert via one or more communication channels such as an SMS service 330 which delivers an SMS to a cell phone 336, a mail service which delivers an e-mail to a mail client 338, and/or an XML adapter 334 which sends an XML message to a smartphone 370 (e.g., IPHONE) or other consumer device.

The notification message can include an actionable item that elicits a response from a user. For example, the XML message displayed on the smartphone 370 can include actionable items for the user to request additional information related to the alert (e.g., details needed to approve a transaction, etc.) and/or invoke further actions (e.g., to approve a transaction, etc.). Such a response is sent from the smartphone 370 to an A2X module (web service) 318 to invoke one or more core services 314 of the business object 210. A response to a notification message can also be sent by SMS (using, for example, a short code: Read Receipt for a Supplier Order information, etc.) and/or e-mail (using, for example, voting buttons for shopping cart approval, etc.). An information outbound module 326 within the push service 220 can periodically read responses via SMS or e-mail which in turn can invoke A2X services via the A2X module 318.

The notification messages assembled by the push service 220 can be comprise generic messages, modeled messages, or user-specific messages. For example, a generic messages can be built by the information outbound module 322 based on upon the business configuration (obtained from the business configuration module 324) and the formula and derivation tool 316 defined rules (e.g., BO Purchase Order 4711, ‘Root Node field, order status ‘changed to, Ordered’). A modeled message can comprise delivered content that is modeled by the business object 210 owners (e.g., Purchase Order 3711 got ordered. A user specific message allows a user to configure their own information texts in combination with business object 210 node files (e.g., Consultant John Doe sent time confirmation for my project 0815).

The relevant process information can be defined by information filters, which exist per business objects or other data structures. The filtered information can be grouped into information levels that in turn can be configured for groups of interest to which the consumers belongs (or is registered). Information levels can correspond to any desired granularity level defined by a business object 210. Information levels can, for example, correspond to nodes of the business object 210 (or groups of nodes defined by child-parent relationships). Thus, information levels can be defined as combinations of relevant filters in a business process. The consumers are able to ‘register’ themselves to an information level via a graphical user interface. In some implementations, the formula and derivation tool 316 can be used to obtain user-generated input form the graphical user interface in order to establish notification and rules defining information levels for such notifications. These information levels are used by the business process platform 210 to distribute information to the ‘consumers’. The formula and derivation tool 316 can, for example, be initiated in a business application that includes a menu or other graphical user interface element that lists alerts.

For each information level the business process platform 300 can trace the information sent to the consumers. This arrangement allows for monitoring the information flow and so that a flow history listing all information distributed in a chronological order can be generated. In case of exceptions occurring during the alert process, this history can be used to reconcile the information between the business process platform 300 and the consumers.

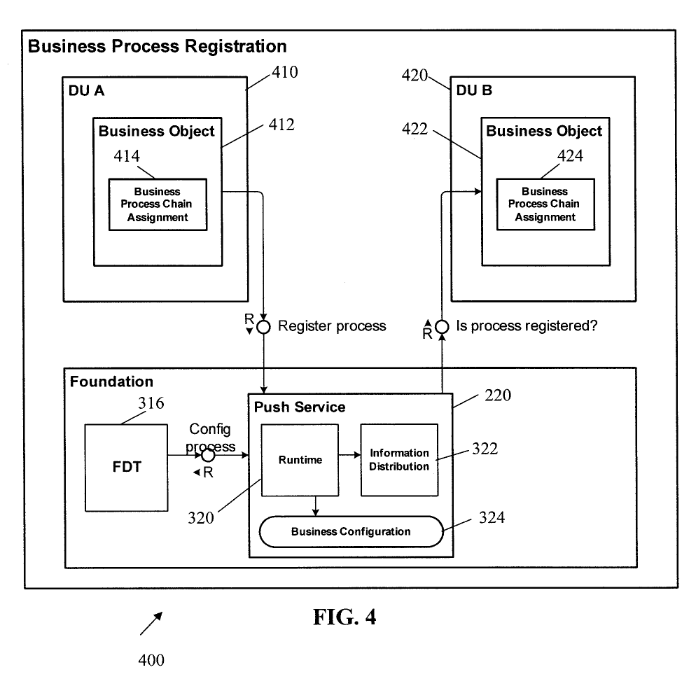

FIG. 4 is a diagram 400 illustrating business process registration that involves a deployment unit A (DU A) 410 and a deployment unit B (DU B) 420. DU A 410 includes a first business object 412 that in turn includes a first business process chain assignment module 414. Similarly, DU B 420 includes a second business object 422 that in turn includes a second business process chain assignment module 424. In case a business process gets started in the first business object 412 and the succeeding second business object 422 gets created afterwards, both business process chain assignment modules can link to the same process ID. As stated above, users can register themselves for specific processes. When a process gets invoked (e.g., project purchasing), a user can explicitly start the process information distribution by configuring, during run-time, formula and derivation tool 316 rules for the process. The system will store the rule configurations for the corresponding process ID (taken from, for example, Data Object BusinessProcessChainAssignment). Formula and derivation tool 316 rule configurations can be sent to any subsequent business object in the process (e.g., PO, GSA, etc.).

With reference again to FIG. 4, the when business object 412 in DU A 410 gets saved, the process agent calls the push service 220 to register the process for the process ID of process chain assignment module 414. When the process continues in business object 422 of DU 420, the agent calls the push service 220 in save transaction phase with the process ID of business process chain assignment module 424 to determine whether the process has been registered in the predecessor business object. If the process had been registered the FDT gets called to evaluate via its rules if some changed data of business object shall be notified via the push service.

In one example, the stakeholders of a project need to be informed about the progress of a key project. This project requires the purchase of third party goods and services. As the purchasing process takes place in a department out of the responsibility of the project, the stakeholders and the project lead want to be informed automatically about the progress. The project lead registers himself to the purchasing process information level which filters data about the purchasing process and configures a preferred distribution channel (e.g., email). As the stakeholders do not want to receive such fine granular information about the purchasing process, they register themselves to a purchasing management information level. Depending on how the purchasing management information level is defined, the stakeholders get only the information that the purchasing process is finished, while the project lead receives information about the intermediate process steps during the purchasing (such as purchase order approval/rejection, etc.).

When the purchasing process is initiated for this project, the project lead gets an email from the Business Process Information System (stating, for example, a purchase order is created and is in approval). In case that the purchase order gets declined, the Business Process Information System will inform the project lead once more via email. As the project lead might want to know the reason, he might use the received information to request further details from the Business Process Information System—in case of his preferred communication channel ‘email’, he might click on a link which triggers the Business Process Information System which in turn will invoke a service. The service will then request further information from the corresponding business object (e.g., Purchase Order) and return this information to Business Process Information System, which will forward it to the project lead. The stakeholders will receive only the key-information when the purchasing process is finished (e.g., a receipt is generated, etc.).

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. An article comprising a tangible machine-readable storage medium embodying instructions that when performed by one or more machines result in operations comprising:
monitoring a data structure to detect changes;
initiating a push service in response to detection of changes;
determining relevance of the detected changes and packaging, by the push service, data characterizing the save event in a message in a predetermined format if it is determined that the detected changes are relevant;
transmitting the message to an output management module; and
initiating, by the output management module, delivery of a notification message to at least one predetermined recipient by a predetermined communication channel.

2. An article as in claim 1, wherein the data structure is a business object.

3. An article as in claim 2, wherein a process agent monitors the business object to detect the changes in a save phase.

4. An article as in claim 1, wherein the tangible machine-readable storage medium further embodies instructions that when performed by one or more machines result in operations comprising:
accessing a formula and derivation tool repository to determine one or more of the predetermined message format, the at least one predetermine recipient, and the predetermined communication channel.

5. An article as in claim 4, wherein the formula and derivation tool repository defines user-generated information filters.

6. An article as in claim 1, wherein a business configuration module defines at least a portion of the predetermined message format.

7. An article as in claim 1, wherein the communication channel is selected from a group comprising: messaging service, e-mail service, or XML messages.

8. An article as in claim 1, wherein the tangible machine-readable storage medium further embodies instructions that when performed by one or more machines result in operations comprising:
receiving, from a recipient, a response to the notification message; and
initiating a further action in response to the notification message.

9. An article as in claim 8, wherein the further action results in delivery of additional information relating to the detected changes to the at least one predetermined recipient via the predetermined communication channel.

10. An article as in claim 8, wherein the further action results in at least one additional processing step relating to the detected changes being initiated.

11. An article as in claim 7, wherein the response invokes an A2X service.

12. A method for implementation in a service-oriented architecture comprising:
monitoring a data structure to detect changes during a save phase;
initiating a push service in response to detection of the changes;
determining relevance of the detected changes;
packaging, by the push service, data characterizing the save event in a message in a predetermined format if it is determined that the detected changes are relevant;
transmitting the message to an output management module; and
initiating, by the output management module, delivery of a notification message to at least one predetermined recipient by a predetermined communication channel.

13. An article comprising a tangible machine-readable storage medium embodying instructions that when performed by one or more machines result in operations comprising:
initiating, by an asynchronous process agent, a push service when a save event occurs in a business object associated with the asynchronous process agent, the asynchronous process agent providing the push service with data characterizing the save event;
determining, by the push service using a formula and derivation tool, a notification event associated with the save event;
modifying, by a business configuration module in the push service, the data characterizing the save event into a format compatible with the notification event;
transmitting, by an information outbound module in the push service to an outbound management module, the data characterizing the save event into a format compatible with the notification event;
initiating transportation of the data characterizing the save event into a format compatible with the notification event via a delivery channel specified by the formula and derivation tool to a user; and
receiving feedback from the user to enable initiation of a core service of the business object.

14. An article as in claim 13, wherein an output management module initiates the transport of the data characterizing the save event.

15. An article as in claim 14, wherein the output management module receives a user-generated response, and wherein the tangible machine-readable storage medium further embodies instructions that when performed by one or more machines result in operations comprising:
calling an information inbound module in the push service with the response;
invoking, by the information inbound module, an A2X service defined by the response; and
invoking, by the A2X service, the core service associated with the data structure.

16. An article as in claim 13, wherein the feedback is received via an A2X service invocation.

17. An article as in claim 13, wherein the delivery channel comprises one or more of a messaging service, an e-mail service, and an XML adapter.

18. An article as in claim 13, wherein the formula and derivation tool comprises user-generated information filters.

19. An article as in claim 13, wherein the tangible machine-readable storage medium further embodies instructions that when performed by one or more machines result in operations comprising:
initiating, by the invoked core service, delivery of additional data associated with the notification event to the user via the delivery channel.

20. An article as in claim 13, wherein the tangible machine-readable storage medium further embodies instructions that when performed by one or more machines result in operations comprising:
initiating, by the invoked core service, additional process steps associated with the notification event.
